(19) United States
(12) Patent Application Publication
(10) Pub. No.: US 2012/0154110 A1
(43) Pub. Date: Jun. 21, 2012

(54) COORDINATES DETECTING DEVICE, DISPLAY APPARATUS, SECURITY APPARATUS AND ELECTRONIC BLACKBOARD INCLUDING THE SAME

(75) Inventors: Byung Hoon KIM, Suwon (KR); Joo Young HA, Suwon (KR)

(73) Assignee: SAMSUNG ELECTRO-MECHANICS CO., LTD.

(21) Appl. No.: 13/324,548

(22) Filed: Dec. 13, 2011

(30) Foreign Application Priority Data
Dec. 15, 2010 (KR) 10-2010-0128479

(51) Int. Cl. G06F 7/04; G06F 3/043

(52) U.S. Cl. 340/5.7; 345/177

(57) ABSTRACT

There are provided a coordinates detecting device for detecting coordinates of an event generated in a region of interest, and a display apparatus, a security apparatus and an electronic blackboard including the same. The coordinates detecting device provided on at least one side of a touch panel having a preset region of interest surrounded by a frame having a predetermined length, includes: a voltage generator providing a preset driving voltage; an acoustic wave to voltage converter receiving the driving voltage from the voltage generator, to thereby generate a predetermined ultrasonic wave, and receiving the ultrasonic wave reflected from the region of interest to convert the received ultrasonic wave to a corresponding voltage level; and a calculator calculating a position from which the ultrasonic wave is reflected according to the voltage level converted from the acoustic wave to voltage converter.

### CROSS-REFERENCE TO RELATED APPLICATIONS

This application claims the priority of Korean Patent Application No. 10-2010-0128479 filed on Dec. 15, 2010, in the Korean Intellectual Property Office, the disclosure of which is incorporated herein by reference.

### BACKGROUND OF THE INVENTION

1. Field of the Invention

The present invention relates to a coordinates detecting device, an apparatus for detecting corresponding coordinates of an event generated within a region of interest, a display apparatus, a security apparatus and an electronic blackboard including the same.

2. Description of the Related Art

An apparatus for detecting coordinates by sensing a change, etc., generated within a region of interest has been widely used.

In detecting the coordinates of a contact point on a display panel, which is a region of interest in a mobile communications terminal such as a cellular phone, a personal digital assistance (PDA), a notebook computer, or the like, an ultrasound method, an infrared method, a resistive type method, a capacitive type method, and the like, have mainly been used. Recently, the capacitive type method has been mainly used.

Meanwhile, when the size of the display panel, which is the region of interest, is large, a method for detecting the coordinates of an event by using an imaging device such as a camera has been suggested.

Herein, the event, which is an act or a situation generated in the region of interest, such as a touch, may be defined as a change in an image generated in an image sensor of the imaging device.

An apparatus for detecting the coordinates of an event within a region of interest according to the related art has been configured of at least two separated imaging devices receiving image information on the event generated in the region of interest and an imaging processor processing the received image information.

When the at least two separated imaging devices were installed to be directed to the region of interest, there was a limitation in that large amount of installation space was required.

In addition, since the information obtained in the separated imaging devices is transferred to the imaging processor to be combined in the imaging processor, synchronization should be performed during processing of the information. Further, since only one function corresponding to one touch may be performed, a multi-function corresponding to a multi-touch may not be performed.

### SUMMARY OF THE INVENTION

An aspect of the present invention provides a device for detecting the coordinates of an event generated within a region of interest, which is capable of processing information on the generated event by using only one module.

Another aspect of the present invention provides a display apparatus, a security apparatus and an electronic blackboard including the device for detecting coordinates of an event generated within a region of interest.

According to an aspect of the present invention, there is provided a coordinates detecting device provided on at least one side of a touch panel having a preset region of interest surrounded by a frame having a predetermined length, the coordinates detecting device including: a voltage generator providing a preset driving voltage; an acoustic wave to voltage converter receiving the driving voltage from the voltage generator to thereby generate a predetermined ultrasonic wave, and receiving the ultrasonic wave reflected from the region of interest to convert the received ultrasonic wave to a corresponding voltage level; and a calculator calculating a position from which the ultrasonic wave is reflected, according to the voltage level converted from the acoustic wave to voltage converter.

The coordinates detecting device may further include a controller controlling a voltage level of the driving voltage of the voltage generator or a difference in time at which the driving voltage is generated, and controlling the calculating of the position of the calculator.

The acoustic wave to voltage converter may be made of polyvinylidene fluoride (PVDF).

A position of an event generated in the region of interest may be triangulated by the coordinates detecting device provided on at least one side and the other side of the touch panel.

The acoustic wave to voltage converter provided on the one side and the acoustic wave to voltage converter provided on the other side may generate ultrasonic waves having different frequencies. The acoustic wave to voltage converter provided on the one side and the acoustic wave to voltage converter provided on the other side may generate ultrasonic waves having the same frequency at different times.

According to another aspect of the present invention, there is provided a display apparatus, including: a display panel that is a region of interest; a support frame supporting the display panel; and a coordinates detecting device disposed on one side of the support frame, wherein the coordinates detecting device includes: a voltage generator providing a preset driving voltage; an acoustic wave to voltage converter receiving the driving voltage from the voltage generator to thereby generate a predetermined ultrasonic wave toward the display panel, and receiving the ultrasonic wave reflected from the region of interest to convert the received ultrasonic wave to a corresponding voltage level; and a calculator calculating a position from which the ultrasonic wave is reflected according to the voltage level converted from the acoustic wave to voltage converter.

The coordinates detecting device may be provided on at least one side and the other side of the support frame to triangulate a position of an event generated in the region of interest.

The support frame may include inner sides disposed toward the display panel formed along circumference of the display panel, and the inner sides are provided with reflective surfaces reflecting the ultrasonic waves from the coordinates detecting device or absorption surfaces absorbing the ultrasonic waves from the coordinates detecting device.

According to another aspect of the present invention, there is provided a security apparatus, including: a coordinates detecting device; and a controller receiving wire- or wireless-transmitted information of an event in the coordinates detecting device to control opening and closing of a door, wherein the coordinates detecting device includes: a voltage generator providing a preset driving voltage; an acoustic wave to voltage converter receiving the driving voltage from the voltage generator to thereby generate a predetermined ultrasonic wave toward the door that is a region of interest, and receiving the ultrasonic wave reflected from the region of interest to convert the received ultrasonic wave into a corresponding voltage level; and a calculator calculating a position from which the ultrasonic wave is reflected according to the voltage level converted from the acoustic wave to voltage converter.

According to another aspect of the present invention, there is provided an electronic blackboard, including: a display board that is a region of interest and displays a trace of an event generated in region of interest; and a coordinates detecting device, wherein the coordinates detecting device includes: a voltage generator providing a preset driving voltage; an acoustic wave to voltage converter receiving the driving voltage from the voltage generator, to thereby generate a predetermined ultrasonic wave toward the region of interest, and receiving the ultrasonic wave reflected from the region of interest to convert the received ultrasonic wave to a corresponding voltage level; and a calculator calculating a position from which the ultrasonic wave is reflected according to the voltage level converted from the acoustic wave to voltage converter.

The apparatus for detecting coordinates maybe provided on at least one side and the other side of the display board to triangulate a position of an event generated in the region of interest.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view of a coordinates detecting device according to an exemplary embodiment of the present invention;

FIG. 2 is an enlarged view of part A of FIG. 1;

FIG. 3 is a schematic view describing coordinate calculation of a coordinates detecting device according to an exemplary embodiment of the present invention;

FIGS. 4A and 4B are respectively schematic views of a coordinates detecting device according to another exemplary embodiment of the present invention;

FIG. 5 is a schematic perspective view of a display apparatus to which a coordinates detecting device according to an exemplary embodiment of the present invention is applied;

FIG. 6 is a schematic perspective view showing another exemplary embodiment of the display apparatus shown in FIG. 5;

FIG. 7 is a schematic perspective view of a security apparatus to which a coordinates detecting device according to an exemplary embodiment of the present invention is applied; and

FIG. 8 is a schematic perspective view of an electronic blackboard to which a coordinates detecting device according to an exemplary embodiment of the present invention is applied.

### DETAILED DESCRIPTION OF THE PREFERRED EMBODIMENT

Hereinafter, exemplary embodiments of the present invention will now be described in detail with reference to the accompanying drawings.

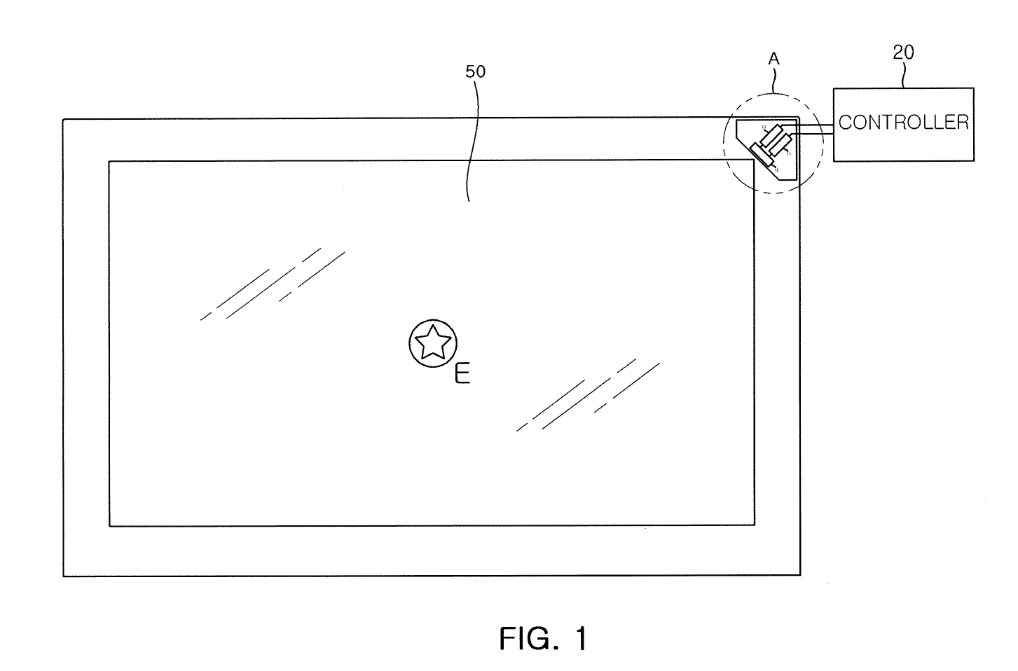

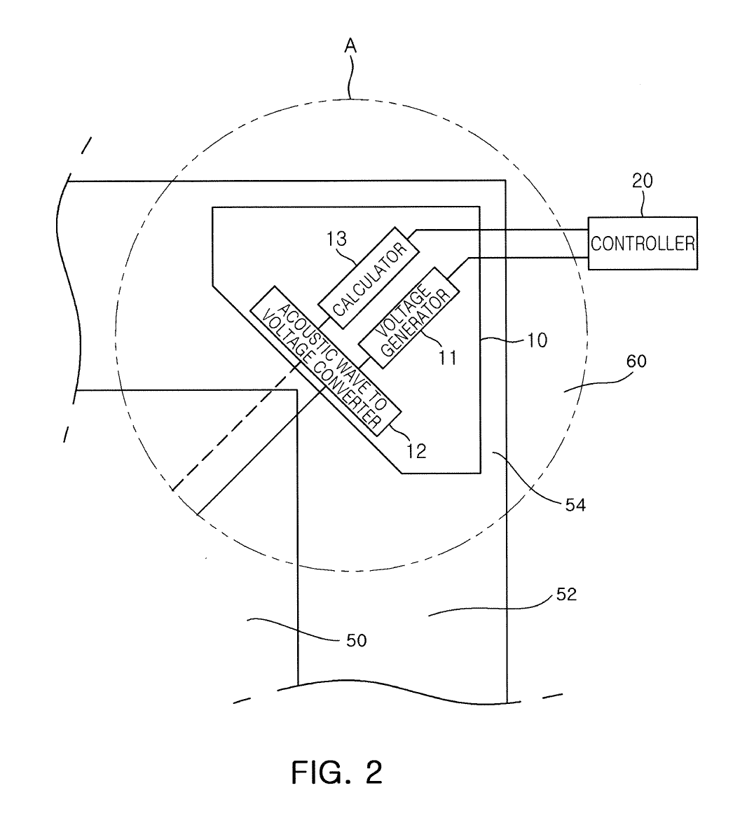

FIG. 1 is a schematic view describing a principle of a coordinates detecting device according to an exemplary embodiment of the present invention, and FIG. 2 is an enlarged view of part A of FIG. 1.

Referring to FIGS. 1 and 2, a coordinates detecting device 10 according to an exemplary embodiment of the present invention may include a voltage generator 11, an acoustic wave to voltage converter 12, and a calculator 13, and may further include a controller 20.

Voltage from the voltage generator 11 may be transferred to the acoustic wave to voltage converter 12, and the acoustic wave to voltage converter 12 may transmit an acoustic wave corresponding to the transferred voltage level to scan a region of interest 50 of the coordinates detecting device 10. The region of interest 50 is a region of coordinates which the coordinates detecting device 10 is to detect. Broadly, any two dimensional plane may become an object of the region of interest 50.

The coordinates detecting device 10 may also be mounted on an edge of one side of the region of interest 50.

The voltage generator 11 may transfer driving voltage having a preset voltage level to the acoustic wave to voltage converter 12. The acoustic wave to voltage converter 12 may convert the driving voltage into an acoustic wave, more specifically, an ultrasonic wave corresponding to the voltage level of the driving voltage and radially scan the acoustic wave to scan the region of interest 50. Accordingly, the acoustic wave to voltage converter 12 may scan light, while rotating at a preset angle from a reference plane of the region of interest 50, to scan the region of interest 50. In addition, the voltage generator 11 may supply the driving voltage at a preset time. To this end, the coordinates detecting device 10 may include the controller 20 capable of controlling supply time of the driving voltage from the voltage generator 11.

Although the region of interest 50 is shown as having a rectangular shape in FIG. 1, it may have various shapes. Herein, a boundary of the region of interest 50 may be configured of a support frame supporting the region of interest 50. The support frame is denoted by a reference numeral 52, an region of the support frame 52 in which the coordinates detecting device 10 may be installed is denoted by a reference numeral 54, and a touch panel including the support frame 52 supporting the region of interest 50 is denoted by a reference numeral 60.

When there is an event E generated in the region of interest 50, an ultrasonic wave reflected and received by the event may be transferred to the coordinates detecting device 10. Herein, the event E maybe defined as an act or a situation, which becomes a detection object of the coordinates which the coordinates detecting device 10 is to detect.

The received ultrasonic wave is converted into a corresponding voltage level by the acoustic to voltage converter 12, and the calculator 13 may detect a generation position of the event E by the converted voltage level and a transmission time, a transmission angle, and the like, of the received ultrasonic wave.

The acoustic to voltage converter 12 may be made of a film-shaped polyvinylidene fluoride (PVDF). Schematically describing the PVDF, the PVDF, which has a —(CH₂—CF₂—CH₂—CF₂—)n— structure, has a high dipole moment, and has an electrical dipole moment appearing in a direction perpendicular to a molecule ring. Accordingly, owing to electrical repulsive force between dipole in two polymer chains, when an electric field is applied to the PVDF from the outside, a distance between molecules is reduced due to attractive force of the dipole, such that piezoelectric effect of reducing a total thickness of the a PVDF thin film is generated. When heat or the electric field is applied to the PVDF from the outside using the characteristic, charges appears on both surfaces thereof, whereby the PVDF may lead out the signal and may be used as a sensor. That is, when external pressure, vibration, shock, and the like, is applied to the PVDF, the PVDF may obtain an electrical output due to positive piezoelectric effect, and when alternating current voltage is applied thereto, the PVDF maybe generate the acoustic wave, particularly, the ultrasonic wave through vibration due to the negative piezoelectric effect.

The coordinates detecting device 10 may include the controller 20 controlling the supply time of the driving voltage of the voltage generator 11 and position calculation of the calculator 13 therein. Meanwhile, the controller 20 may be formed as a separate module outside the coordinates detecting device 10. When the controller 20 is formed as the separate module outside the coordinates detecting device 10, it may perform wired or wireless communication with the voltage generator 11 and the calculator 13. The controller 20 may control the voltage generator 11 to supply pulse voltage to the acoustic wave to voltage converter 12 at a preset time, and may also control the level of the voltage to control generation period or frequency of the ultrasonic wave for detecting the generation position of the event E.

Hereinafter, when the event E such as a touch, etc. is generated within the region of interest 50, a method for detecting the coordinates thereof will be described.

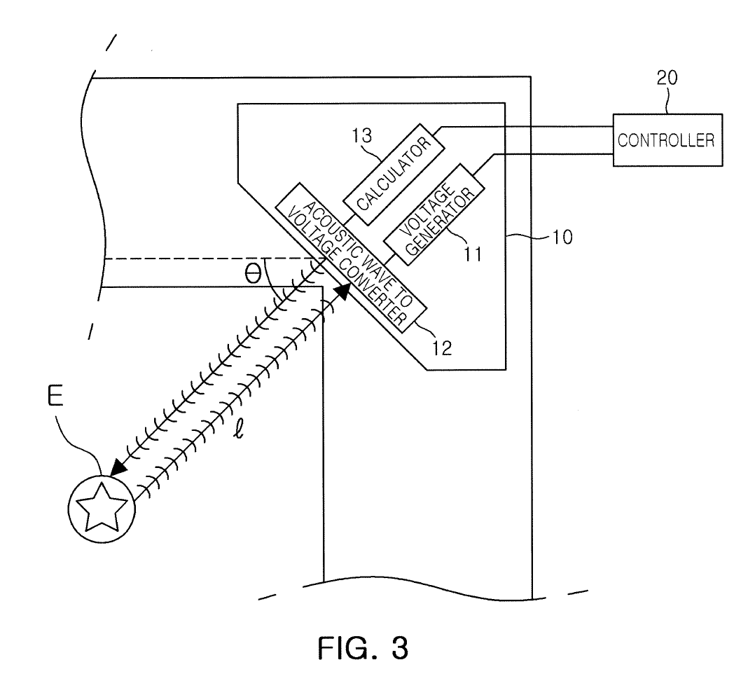

FIG. 3 is a schematic view describing coordinate calculation of a coordinates detecting device according to an exemplary embodiment of the present invention.

Referring to FIG. 3, when the event E such as the touch, etc. is generated within the region of interest 50, the ultrasonic wave outputted from the coordinates detecting device 10 is reflected by the event E to be again transferred to the coordinates detecting device 10.

In FIG. 3, an angle between the ultrasonic wave discharged from the acoustic wave to voltage converter 12 and the ultrasonic wave reflected by the event E, and a reference plane of the region of interest 50 is denoted by θ, and a length from the event E to the acoustic wave to voltage converter 12 is denoted by 1.

The controller 20 may set unit time at which the voltage generator 11 supplies the driving voltage to the acoustic wave to voltage converter 12, and may control the acoustic wave to voltage converter 12 to scan the region of interest 50 by discharging light to the region of interest 50, while rotating at a preset angle for each unit time at which the voltage generator 11 supplies the driving voltage. Accordingly, the angle between the ultrasonic wave discharged from the acoustic wave to voltage converter 12 and the ultrasonic wave reflected by the event E, and the reference plane of the region of interest 50 may be confirmed. In addition, the controller 20 detects that the event has been not generated when the reflected ultrasonic wave of the ultrasonic wave outputted at current unit time at which the voltage generator 11 supplies the driving voltage is received between the current unit time and a next unit time at which the voltage generator 11 will subsequently supply the driving voltage, such that the reflected ultrasonic wave is received within a preset time range, and detects that the event has been generated when the reflected ultrasonic wave is received faster that a preset time, whereby a distance at which the event is generated may be detected by a difference between the generation time of the ultrasonic wave and the received time of the reflected ultrasonic wave. At this time, when the voltage level of the reflected ultrasonic wave is a preset reference level or less, the reflected ultrasonic wave may be detected as a reflected ultrasonic wave of a previous outputted ultrasonic wave, thereby suppressing an error in the position calculation.

The calculator 13 may detect the generation coordinates of the event E in the region of interest 50 of a two-dimensional plane by the above-mentioned angle and distance.

Further, even when the event E is moved, the relative coordinates of a new event can be detected, such that the coordinates detecting device 10 can detect information on the event changing in real time, such as movement, drag, appearance, disappearance, and the like, of the event.

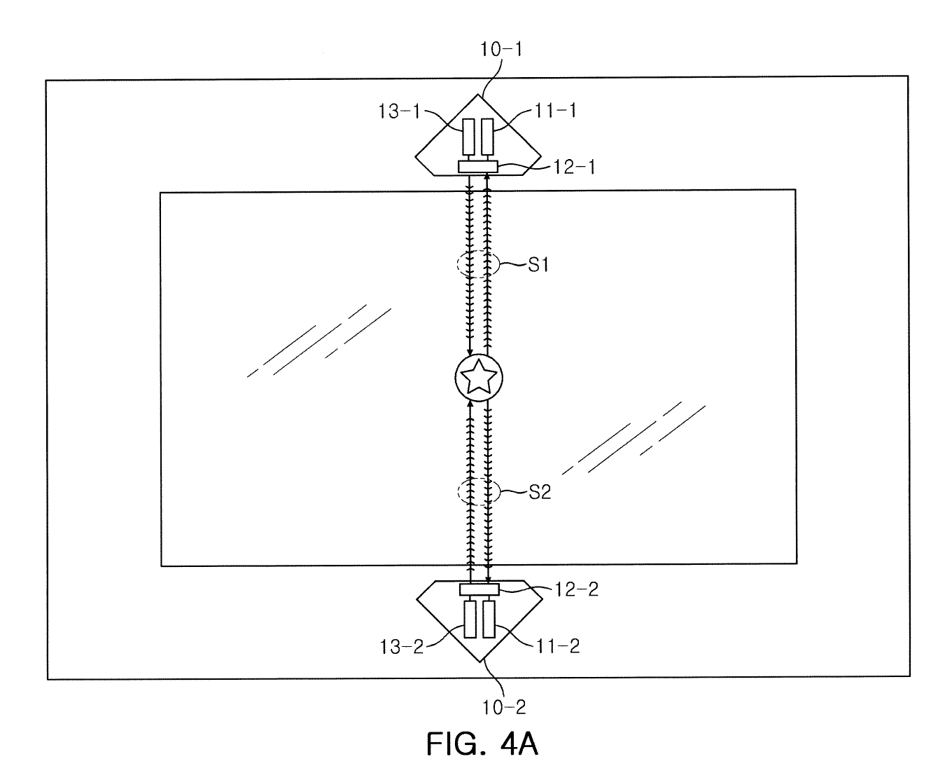

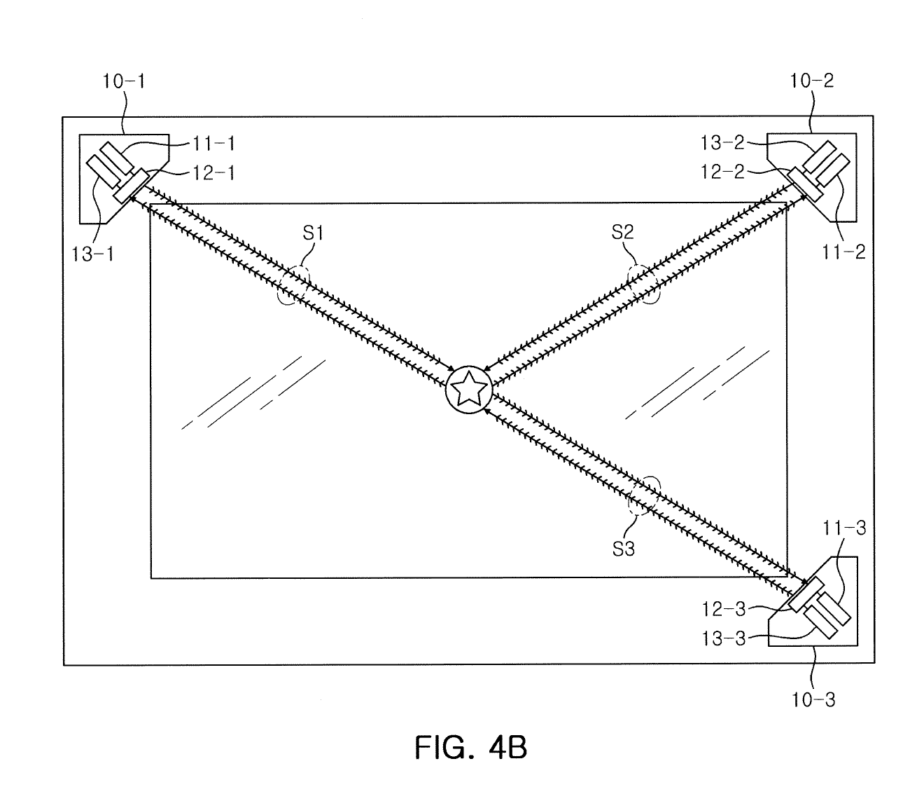

Meanwhile, in order to more accurately detect the information on the event, a plurality of coordinates detecting devices may be provided as shown in FIGS. 4A and 4B.

That is, as shown in FIG. 4A, coordinates detecting devices 10-1 and 10-2 may be provided on one surface and the other surface of the support frame in order more accurately detect the generation position of the event through triangulation. Although not shown, the coordinates detecting devices may also be provided on one side edge and the other side edge.

In addition, as shown in FIG. 4B, coordinates detecting devices 10-1, 10-2, and 10-3 may be provided on three edges of the support frame, respectively. Although not shown, the coordinates detecting devices may also be provided on three surfaces of the support frame, respectively.

As described above, two or three or more coordinates detecting devices 10-1, 10-2, and 10-3 are provided, whereby the generation position of the event may be more accurately detected. To this end, the ultrasonic waves generated in each of the coordinates detecting devices may have different frequencies to be distinguished from each other or may have different generation cycles in the same frequency. The ultrasonic waves generated in each of the coordinates detecting devices may also have the different frequencies and different generation cycles. Further, the coordinates detecting devices 10-1, 10-2, and 10-3 may cite the technical features of the coordinates detecting device 10s as described above, such that a detailed description thereof will be omitted.

Hereinafter, various exemplary embodiments to which the coordinates detecting device 10 as described above is applied will be described. A display apparatus 100, a security apparatus 200, and an electronic blackboard 300 to which the coordinates detecting device 10 is applied will be described in the exemplary embodiments of the present invention by way of example. However, the coordinates detecting device 10 may also be applied to any apparatuses that require the detection of coordinates.

Further, the coordinates detecting device 10 applied thereto may cite the technical features of the coordinates detecting device 10 as described above, such that a detailed description thereof will be omitted.

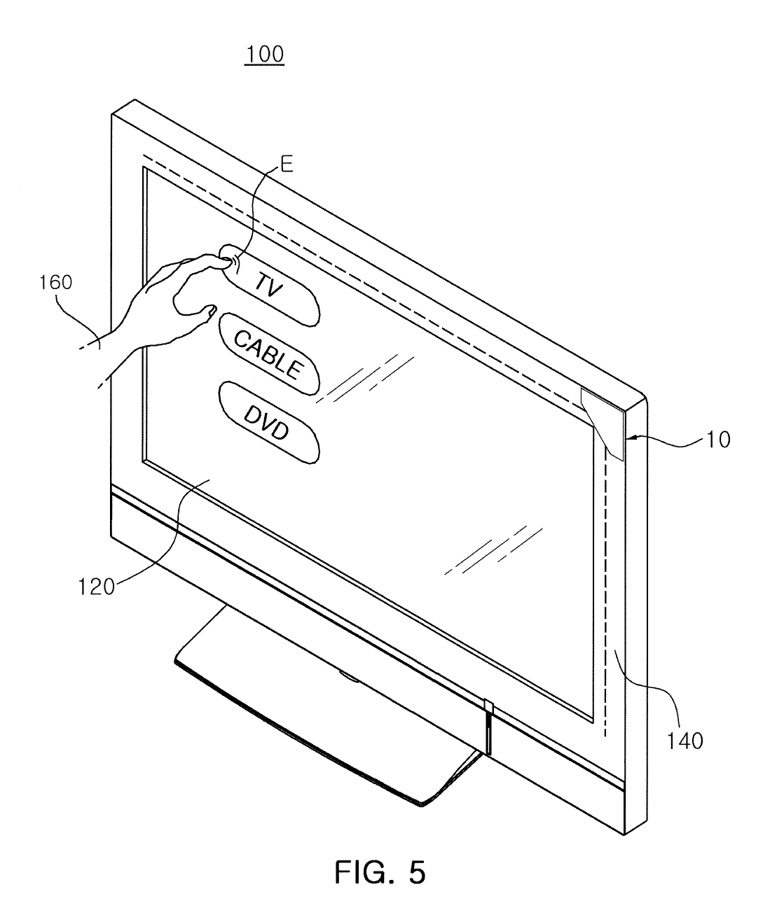

FIG. 5 is a schematic perspective view of a display apparatus to which a coordinates detecting device according to an exemplary embodiment of the present invention is applied.

Referring to FIG. 5, the display apparatus 100 may include a display panel 120, a support frame 140, and the coordinates detecting device 10.

Herein, the display apparatus 100 is an inclusive term including all apparatuses displaying an image, wherein as the display apparatus, there may be a PDP, a LCD, an OLED, an AMOLED, and the like.

The display panel 120 may be the region of interest of the coordinates detecting device 10. The display panel 120 is provided with various user interfaces UIs. Herein, the event E such as the touch, or the like, is generated as an indicating unit on the user interfaces. Herein, a finger 160 is illustrated as the indicating unit in the present embodiment; however, the indicating unit may also means all units that can press the user interface, such as a pen.

The information on the coordinates of the event E may be detected by the coordinates detecting device 10 disposed at one side of the support frame 140. The coordinates detecting device 10 may be included in the support frame 140.

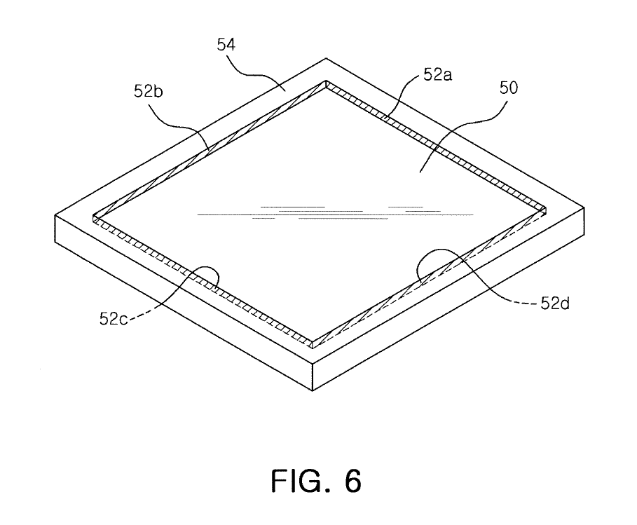

FIG. 6 is a schematic perspective view showing another exemplary embodiment of the display apparatus shown in FIG. 5.

Referring to FIG. 6, the display apparatus may have the support frame 54 formed along circumference of the region of interest 50, wherein the inner sides 54a, 54b, 54c, and 54d toward the region of interest 50 of the sides of the support frame 54 are formed with reflective surfaces reflecting the ultrasonic waves outputted from the apparatuses (not shown) for detecting coordinates or absorption surfaces absorbing the ultrasonic waves outputted therefrom to raise reflectivity of the ultrasonic waves outputted from the apparatuses (not shown) for detecting coordinates or absorb the ultrasonic waves outputted therefrom. Therefore, the ultrasonic waves are reflected only during the generation of the event E, whereby the ultrasonic waves reflected by the event E may be received to suppress an error generated when the coordinate of the event E is detected.

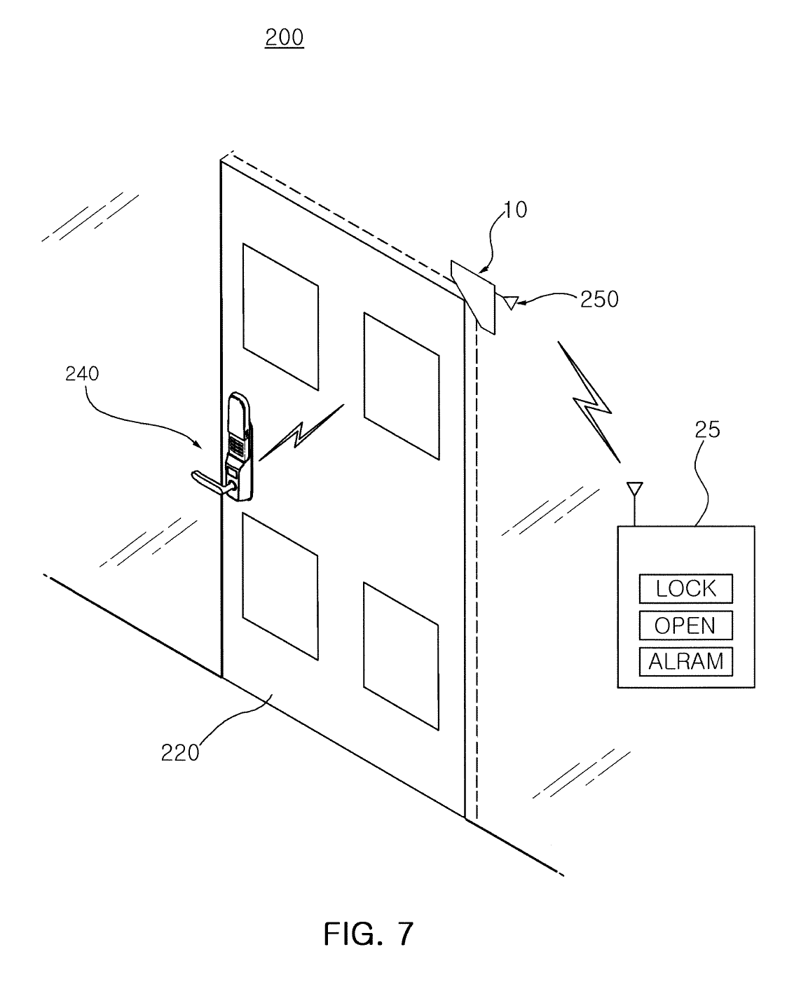

FIG. 7 is a schematic perspective view of a security apparatus to which a coordinates detecting device according to an exemplary embodiment of the present invention is applied.

Referring to FIG. 7, a security apparatus 200 may include a door 220, the coordinates detecting device 100, and a controller 25.

The door 220 may be the region of interest of the coordinates detecting device 10. The coordinates detecting device 10 is installed to provide infrared light toward the door 220. At this time, the coordinates detecting device 10 may be installed at one side wall of a main surface of the door 200.

Herein, an event maybe generated as a human or an object stands or passes in front of the door 220 as well as does a certain action within the region of interest. The coordinates detecting device 10 may detect the event to provide the information to the controller 25, and the controller 25 may drive a door lock 240 according to the event to open/close the door 200 or sound an alarm.

A case where data is transmitted in wireless to the coordinates detecting device 10 by a radio data transmitter 250 is illustrated in the present embodiment; however, the data may also be transmitted in wire.

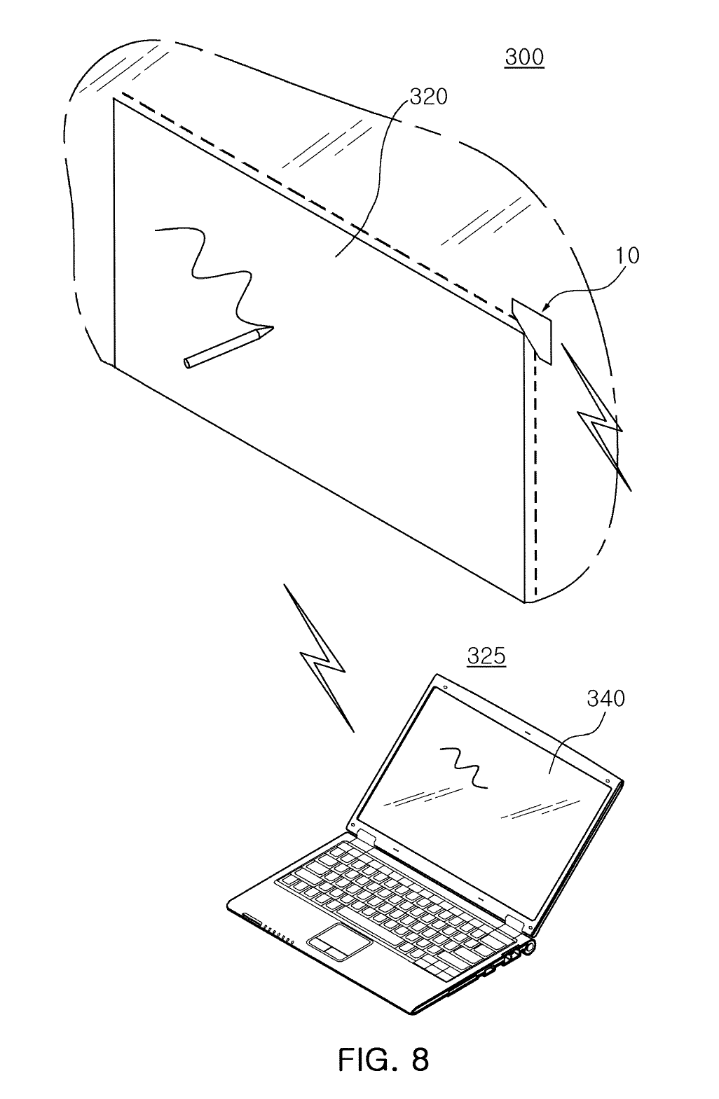

FIG. 8 is a schematic perspective view of an electronic blackboard to which a coordinates detecting device according to an exemplary embodiment of the present invention is applied.

Referring to FIG. 8, an electronic blackboard 300 may include a board 320 and the coordinates detecting device 10.

Herein, the board 320, which is the region of interest of the coordinates detecting device 10, may be a simple wall or anything capable of being used as a black board.

The coordinates detecting device 10 may be disposed at one side of the board 320 to detect image information, such as writings, pictures, etc. written on the board 320.

Although not shown, the board 320 has the support frame as in the display apparatus of FIG. 6, wherein inner sides of the support frame may be formed with reflective surfaces or absorption surfaces.

The data information stored in the coordinates detecting device 10 may be transmitted to a user information apparatus 325 that is connected in wire or wireless, such as a notebook computer or a smart phone, etc. The event (writings, pictures, etc.) written on the board 320 may be displayed by the display panel 340 through the transmitted data.

As set forth above, according to the coordinates detecting device, the display apparatus, the security apparatus and the electronic blackboard including the same according to exemplary embodiments of the present invention, the event and the coordinates within the region of interest may be detected by using at least one coordinates detecting device, whereby the installation space, installation time, and the like, of the coordinates detecting device may be reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. A coordinates detecting device provided on at least one side of a touch panel having a preset region of interest surrounded by a frame having a predetermined length, the coordinates detecting device comprising:
a voltage generator providing a preset driving voltage;
an acoustic wave to voltage converter receiving the driving voltage from the voltage generator to thereby generate a predetermined ultrasonic wave, and receiving the ultrasonic wave reflected from the region of interest to convert the received ultrasonic wave to a corresponding voltage level; and
a calculator calculating a position from which the ultrasonic wave is reflected, according to the voltage level converted from the acoustic wave to voltage converter.

2. The coordinates detecting device of claim 1, further comprising a controller controlling a voltage level of the driving voltage of the voltage generator or a difference in time at which the driving voltage is generated, and controlling the calculating of the position of the calculator.

3. The coordinates detecting device of claim 1, wherein the acoustic wave to voltage converter is made of polyvinylidene fluoride (PVDF).

4. The coordinates detecting device of claim 2, wherein a position of an event generated in the region of interest is triangulated by the coordinates detecting device provided on at least one side and the other side of the touch panel.

5. The coordinates detecting device of claim 4, wherein the acoustic wave to voltage converter provided on the one side and the acoustic wave to voltage converter provided on the other side generate ultrasonic waves having different frequencies.

6. The coordinates detecting device of claim 4, wherein the acoustic wave to voltage converter provided on the one side and the acoustic wave to voltage converter provided on the other side generate ultrasonic waves having the same frequency at different times.

7. A display apparatus, comprising:
a display panel that is a region of interest;
a support frame supporting the display panel; and
a coordinates detecting device disposed on one side of the support frame,
wherein the coordinates detecting device includes:
a voltage generator providing a preset driving voltage;
an acoustic wave to voltage converter receiving the driving voltage from the voltage generator to thereby generate a predetermined ultrasonic wave toward the display panel, and receiving the ultrasonic wave reflected from the region of interest to convert the received ultrasonic wave to a corresponding voltage level; and
a calculator calculating a position from which the ultrasonic wave is reflected according to the voltage level converted from the acoustic wave to voltage converter.

8. The display apparatus of claim 7, wherein the coordinates detecting device further includes a controller controlling a voltage level of the driving voltage of the voltage generator or a difference in time at which the driving voltage is generated, and controlling the calculating of the position of the calculator.

9. The display apparatus of claim 7, wherein the acoustic wave to voltage converter is made of polyvinylidene fluoride (PVDF).

10. The display apparatus of claim 8, wherein the coordinates detecting device is provided on at least one side and the other side of the touch panel to triangulate a position of an event generated in the region of interest.

11. The display apparatus of claim 10, wherein the acoustic wave to voltage converter of the the coordinates detecting device provided on the one side and the acoustic wave to voltage converter of the the coordinates detecting device provided on the other side generate ultrasonic waves having different frequencies.

12. The display apparatus of claim 10, wherein the acoustic wave to voltage converter of the the coordinates detecting device provided on the one side and the acoustic wave to voltage converter of the the coordinates detecting device provided on the other side generate ultrasonic waves having the same frequency at different times.

13. The display apparatus of claim 7, wherein the support frame includes inner sides disposed toward the display panel formed along circumference of the display panel, and
the inner sides are provided with reflective surfaces reflecting the ultrasonic waves from the coordinates detecting device or absorption surfaces absorbing the ultrasonic waves from the coordinates detecting device.

14. A security apparatus, comprising:
a coordinates detecting device; and
a controller receiving wire- or wireless-transmitted information of an event in the coordinates detecting device to control opening and closing of a door,
wherein the coordinates detecting device includes:
a voltage generator providing a preset driving voltage;
an acoustic wave to voltage converter receiving the driving voltage from the voltage generator to thereby generate a predetermined ultrasonic wave toward the door that is a region of interest, and receiving the ultrasonic wave reflected from the region of interest to convert the received ultrasonic wave into a corresponding voltage level; and
a calculator calculating a position from which the ultrasonic wave is reflected according to the voltage level converted from the acoustic wave to voltage converter.

15. The security apparatus of claim 14, wherein the coordinates detecting device further includes a controller controlling a voltage level of the driving voltage of the voltage generator or a difference in time at which the driving voltage is generated, and controlling the calculating of the position of the calculator.

16. The security apparatus of claim 15, wherein the acoustic wave to voltage converter is made of polyvinylidene fluoride (PVDF).

17. An electronic blackboard, comprising:
a display board that is a region of interest and displays a trace of an event generated in the region of interest; and
a coordinates detecting device,
wherein the coordinates detecting device includes:
a voltage generator providing a preset driving voltage;
an acoustic wave to voltage converter receiving the driving voltage from the voltage generator, to thereby generate a predetermined ultrasonic wave toward the region of interest, and receiving the ultrasonic wave reflected from the region of interest to convert the received ultrasonic wave to a corresponding voltage level; and
a calculator calculating a position from which the ultrasonic wave is reflected according to the voltage level converted from the acoustic wave to voltage converter.

18. The electronic blackboard of claim 17, wherein the coordinates detecting device further includes a controller controlling a voltage level of the driving voltage of the voltage generator or a difference in time at which the driving voltage is generated, and controlling the calculating of the position of the calculator.

19. The electronic blackboard of claim 18, wherein the acoustic wave to voltage converter is made of polyvinylidene fluoride (PVDF).

20. The electronic blackboard of claim 19, wherein the coordinates detecting device is provided on at least one side and the other side of the display board to triangulate a position of an event generated in the region of interest.

21. The electronic blackboard of claim 20, wherein the acoustic wave to voltage converter of the coordinates detecting device provided on the one side and the acoustic wave to voltage converter of the coordinates detecting device provided on the other side generate ultrasonic waves having different frequencies.

22. The electronic blackboard of claim 20, wherein the acoustic wave to voltage converter of the coordinates detecting device provided on the one side and the acoustic wave to voltage converter of the coordinates detecting device provided on the other side generate ultrasonic waves having the same frequency at different times.
